(19) United States
(12) Patent Application Publication
(10) Pub. No.: US 2008/0230752 A1
(43) Pub. Date: Sep. 25, 2008

(54) Control of Lattice Spacing Within Crystals

(76) Inventors: Christopher L. Bower, Cambridgeshire (GB); David Snoswell, Bristol (GB); Brian Vincent, Bristol (GB)

Correspondence Address: EASTMAN KODAK COMPANY;PATENT LEGAL STAFF, 343 STATE STREET, ROCHESTER, NY, 14650-2201, US

(21) Appl. No.: 11/813,487

(22) PCT Filed: Dec. 22, 2005
(86) PCT No.: PCT/GB2005/005029

§ 371 Date: Jul. 6, 2007

(30) Foreign Application Priority Data
Dec. 23, 2004 (GB) 0428261.2

(51) Int. Cl. G02B 5/20; H05F 3/00

(52) U.S. Cl. 252/584; 204/164; 204/165

(57) ABSTRACT

A method of creating and controlling the particle spacing of a regular lattice of monodisperse particles or a mixture of monodisperse particles by using an electric field.

### FIELD OF THE INVENTION

The invention relates to the field of crystals, in particular to the control of the lattice spacing between the particles in the crystals.

### BACKGROUND OF THE INVENTION

It is known in the prior art that photonic crystals have a wide variety of applications in optoelectronics, lasers, flat lenses, sensors, wavelength filters and display devices. A common route to fabrication of photonic crystals is to use self-assembly of colloids into colloidal crystals. This self-assembly process can be achieved by a range of different methods such as sedimentation, centrifugation, filtration, shear alignment or evaporative deposition. It is further known that electric fields can be used to assemble close packed arrays of colloids. For example see (Electrophoretic assembly of colloidal crystals with optically tunable micropatterns R. C. Hayward, D. A. Saville & I. A. Aksay, Nature, vol 404, p 56, 2000) and references cited therein. Further examples of colloidal crystals assembled by using an AC voltage applied to two planar electrodes can be found in “Electric Field-Reversible Three-Dimensional Colloidal Crystals” Tieying Gong, David T. Wu, and David W. M. Marr, Langmuir, vol 19 p 5967, 2003 and “Two-Dimensional Crystallization of Microspheres by a Coplanar AC Electric Field”, Simon O. Lumsdon, Eric W. Kaler, and Orlin D. Velev, Langmuir, vol 20, p 2108, 2004.

The use of a quadrapole electrode structure to generate non-uniform electric field gradients for the control and manipulation of particles by dielectrophoresis is well known; some of the earliest examples were described by H. P. Pohl in “Dielectrophoresis” Cambridge University Press (1978). Furthermore the application of a rotating electric field, often termed ‘electrorotation’ for manipulation of particles (mostly biological such as cells) in liquid suspension is also well known, see for instance Jones, T. B. “Electromechanics of Particles” (Cambridge University Press, Cambridge, 1995, p 83). In particular the use of a quadrapole electrode structure to apply a rotating electric field has also been described within U.S. Pat. No. 6,056,861.

However, none of this prior art suggests the use of an electric field to actively control the lattice spacing of the colloidal crystal assembled in the manner described herein.

Typically the lattice spacing of the crystal is determined by the diameter of the close packed, monodispersed spheres, and remains fixed once the crystal structure has formed.

It is useful to be able to control the lattice spacing of a photonic crystal since this parameter determines the position of the optical stop band, and therefore the wavelength of light that will be reflected since propagation within the crystal is forbidden. The ability to interactively tune the lattice spacing within a photonic crystal is therefore a desirable property since it allows for the creation of a variety of electro-optical devices. A method of creating a tuneable photonic crystal has been described in U.S. Pat. No. 5,281,370 and also more recently US20040131799. However both of these methods of changing the lattice spacing are realized with a photonic crystal embedded in a polymer matrix which is geometrically deformed. This is significantly different from the present invention which uses an electrostatic field to interactively control the spacing of a photonic crystal in liquid suspension. A limitation of embedding the photonic crystal within a polymer matrix is that the crystals tend to be polycrystalline in nature. This leads to an increase in the width, reduction in the intensity and uncertainty in the position of the reflected peak. The range over which the lattice spacing can be tuned within these systems is limited by the flexibility of the polymer matrix, which restricts the wavelength range over which a device might operate. Furthermore, the speed with which the lattice spacing can be changed is also dependent upon how rapidly the polymer matrix can be compressed or extended. Typically times in the order of 0.5-1 s are required which makes the photonic crystal in a polymer matrix arrangement unsuitable for a wide range of electro-optical devices, such as optical switches and displays for video-rate applications, that require response times in the order of milliseconds or less.

The benefits of using a photonic crystal as an optical filter within reflective displays have been suggested in WO 00/77566, and also in EP 1359459. However, use of the current invention in such a reflective display device offers further improvements in terms of manufacturability and performance, since instead of requiring three separate photonic crystal filters for red, green and blue pixels there is now the opportunity to use a single tuneable photonic crystal to provide all three colour responses, with fast switching rates that were not possible with polymer embedded photonic crystals.

### PROBLEM TO BE SOLVED BY THE INVENTION

The aim of the invention is to provide a method of controlling the lattice spacing of particles in a suspension that does not suffer from the problems and limitations of the methods known in the prior art.

### SUMMARY OF THE INVENTION

The present invention uses an electric field to interactively control the spacing of a photonic crystal in liquid suspension.

According to the present invention there is provided a method of controlling the particle spacing of a regular lattice of substantially monodisperse particles or a mixture of particles by use of an electric field.

The present invention allows the dynamic, reversible control of particle spacing within crystals along two independent axes. As the particles are charged electrostatic forces prevent the surfaces from touching. However the particles are held in a hexagonal close packed (HCP) pattern by temporary dipoles induced by the electric field. Since the separation of the particles within the crystal is controlled by the electric field changing the field intensity can change the lattice spacing. The changes to the lattice spacing are reversible and rapid, occurring within a fraction of a second.

### ADVANTAGEOUS EFFECT OF THE INVENTION

The present invention allows accurate, reversible, dynamic positioning of the particles in a suspension. The spacing can be controlled in a rapid, reversible and reproducible manner. The present invention also allows the aspect ratio to be controlled, i.e. the spacing can be different along different axes.

The features and advantages of the present invention will become apparent from the following description, in connection with the accompanying drawings.

### BRIEF DESCRIPTION OF THE DRAWINGS

FIG. 1 is a schematic view of the layout of the electrodes used in an embodiment of the present invention;

FIG. 2 is a graph illustrating particle to particle separation versus field strength using a non rotating electric field;

FIG. 3 is a graph illustrating particle to particle separation versus field strength using a rotating electric field; and

FIG. 4 is a further graph illustrating lattice spacing versus applied field strength.

### DETAILED DESCRIPTION OF THE INVENTION

FIG. 1 illustrates the layout of the electrodes used to demonstrate the method of the invention.

Four electrodes, 1, 2, 3 and 4, are arranged around an observation region. Electrodes 1 and 2 are connected to a signal amplifier 5. Electrodes 3 and 4 are connected to a signal amplifier 6. The four electrodes are co-planar. In the experiments conducted the distance between electrodes 1, 4 and 2, 3 are 159 μm. The distance between electrodes 1, 3 and 2, 4 are 142 μm. However, the gap can be adjusted as required. Smaller distances mean lower voltages to achieve the desired effect, i.e. a field strength of order 30000 Vm⁻¹.

The electrodes consist of a 40 nm thick layer of platinum, sputter coated onto a glass microscope slide. Typically a 10 μL aliquot of a dilute suspension of anionic polystyrene latex particles was placed between the electrodes and covered with a microscope coverslip. The edge-to-edge electrical resistance of each electrode was less than 100Ω, resistance between any two electrodes was greater than 5 MΩ with the suspension present. Positive phase shifts refer to signal amplifier 5 leading signal amplifier 6.

The aggregation, motion and particle-particle separations of arrays of monodisperse anionic, polystyrene latex particles synthesised using a standard technique was observed. The particles were characterised using a Brookhaven Zetaplus light scattering instrument, which reported a zeta potential of −40.6 mV in 0.01 mM KCl, and an average diameter of 0.93 μm (polydispersity 0.012).

Experiments were performed with dilute aqueous suspensions (0.29 wt %) at a KCl electrolyte concentration of 0.01 mM. Observations were made in the central region between four electrodes (see FIG. 1), using an optical microscope fitted with a camera and video recording facility. The four coplanar electrodes, 1, 2, 3 and 4, detailed in FIG. 1, were connected to two signal amplifiers, 5 and 6, outputting sinusoidal alternating voltages with a frequency of 1600 Hz. Typically this arrangement produced field strengths of ≈30,000 Vᵣₘₛ m⁻¹, causing the particles to arrange into chains or spinning hexagonal close packed (HCP) crystals, depending on the relative magnitude and phase of the voltages. A summary of the observations follows.

Without any electric field applied, the random Brownian motion of the particles could be clearly observed and the particles did not aggregate. When only one signal amplifier was operating (electrodes 1 and 2 or 3 and 4) the particles spontaneously formed a flexible chain. As more chains formed with time, adjacent chains periodically drifted together to form a hexagonal close packed (HCP) crystal structure. When the field was switched off, the crystal structures ‘dissolved’ through Brownian motion. It was observed that the chains formed with only signal amplifier 5 operating were perpendicular to those formed with only signal amplifier 6 operating.

When both signal amplifiers 5 and 6 were operating with a relative phase shift of 0°, chains were again formed, but this time they were aligned parallel to the x axis in FIG. 1. In relative terms, these chains were rotated at a 45° angle to those chains obtained with a single signal amplifier operating. When both signal amplifiers were operating with a relative phase shift of 180°, chains formed that were aligned parallel to the y axis (FIG. 1), perpendicular to those obtained with no phase shift. When the relative phase shift was 90° however, no intermediate chains formed. Instead, HCP crystals formed within one second. These crystals spun at approximately 5° to 500 revolutions per minute, with a rotational speed inversely proportional to their size. Adjacent crystals periodically drifted and connected together, increasing the size of the crystal and simultaneously decreasing its rotational speed. If one of the signal amplifiers was disconnected, the spinning stopped immediately and portions of the crystals delaminated into chains. Crystals that drifted away from the central region between the electrodes were also observed to gradually delaminate into chains. The speed of rotation was observed to be proportional to the field strength. Switching the relative phase shift to 270° could reverse the direction of the rotation. Alternating the relative phase shift between 90° and 270° every cycle, or halving the frequency of one voltage source prevents rotation of the spinning crystals.

It is known in the prior art that the reversible formation of colloidal crystals can be achieved by the interaction of electrically induced dipoles associated with particles in a suspension. In particular, “Two-Dimensional Crystallization of Microspheres by a Coplanar AC Electric Field” Simon O. Lumsdon, Eric W. Kaler, and Orlin D. Velev, Langmuir, vol 20, p 2108, 2004, used coplanar electrodes to generate a low frequency (<20,000 Hz) alternating electric field (not rotating), causing the assembly of latex particles into chains and subsequent two-dimensional planes. Importantly, the particles in this study were held in crystalline arrays, with their surfaces separated by up to 150 nm. This was achieved by a balance of attractive and repulsive forces. The attractive forces originated from electrically induced dipoles. The electrostatic repulsive forces originated from the charges on the particle surface.

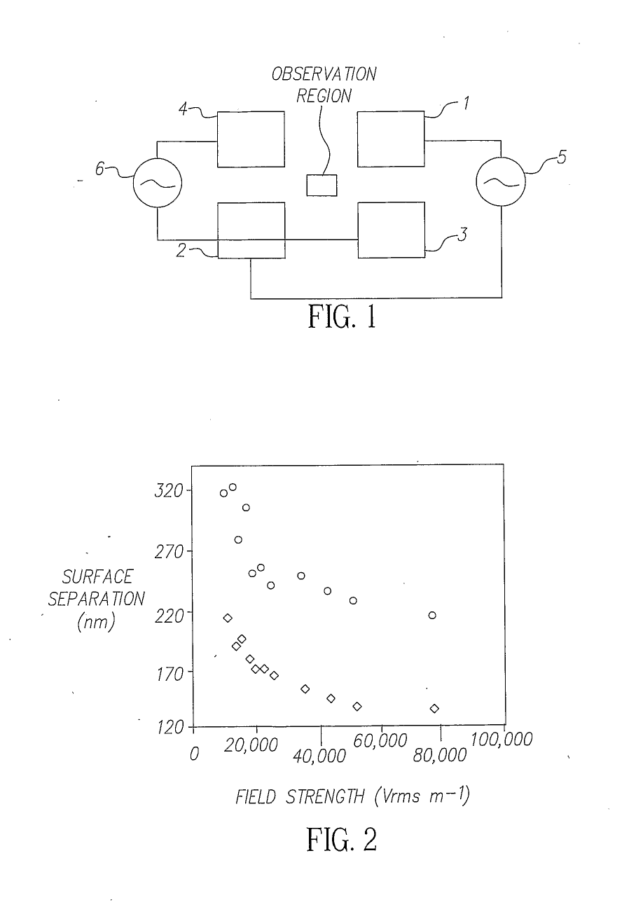

In experiments similar to those of Lumsdon et al involving a non-rotating, alternating electric field between two parallel electrodes (similar to electrodes 1 and 4 in FIG. 1), it was found that the particle-particle surface separations along the field-parallel axis were consistently 65% less than along the field-perpendicular axis. This is illustrated in FIG. 2.

In FIG. 2 all data points refer to particle to particle surface separations measured in a single alternating electric field. Open diamonds indicate particle separations in the field-parallel axis. Open circles indicate particle separations in the field-perpendicular axis.

The crystals were asymmetric (elongated) because the attractive forces between chains were significantly less than between particles in each chain. This was caused by the sub-optimal alignment and restricted positioning of the dipoles in adjacent chains.

It has been found that the asymmetry can be controlled by the use of an electric field.

In the present invention, a coplanar quadrapole electrode has been used to generate a low frequency (1600 Hz) rotating electric field. However frequencies in the range of 100 Hz up to 20 kHz can be used. It will be understood by those skilled in the art that it is not essential to the invention that the electric field is rotating, but it is essential that there is a time dependent change in the field vector.

The rotation of the crystals in the experiments is prevented by periodically alternating the direction in which the electric field rotates (clockwise, anticlockwise). This allowed measurement of the internal spacing within the two dimensional crystal structure.

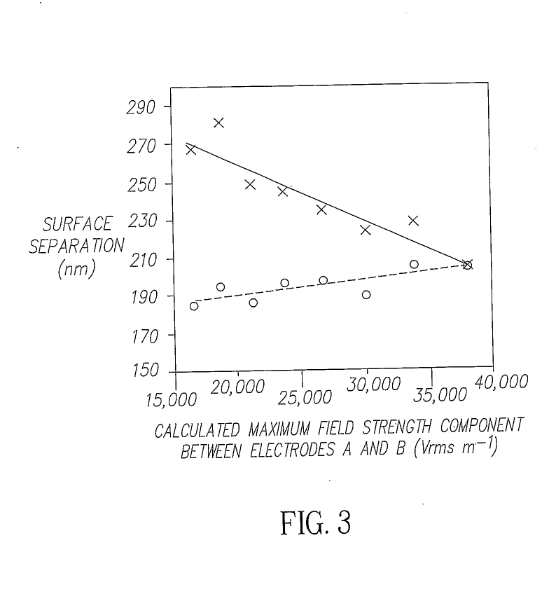

With the rotation of the crystals prevented by alternating the relative phase shift between 90° and 270° every cycle, image analysis of still video frames was performed. Length measurements, calibrated using a gradicule (Gradicules Ser CS1787, 50×2 micron), revealed the particle-particle surface separations along the diagonal axis between electrodes 1 and 2 were approximately the same as those along the diagonal axis between electrodes 3 and 4 provided both signal amplifiers were operating at the same alternating voltage. By reducing the magnitude of the alternating voltage delivered by signal amplifier 5, the particle separations along the axis between electrodes 1 and 2 increased by 34% within the crystal structure. The particle separation along the axis between electrodes 3 and 4 simultaneously decreased by 8%. This is illustrated in FIG. 3.

In FIG. 3 all data points refer to particle-particle surface separations measured within the crystals formed in a rotating electric field. Open circles indicate separations parallel to the axis between electrodes 3 and 4 (±10°). Crosses indicate separations parallel to the axis between electrodes 1 and 2 (±10°). Solid and dashed lines are linear regression fits. For clarity the calculated field strength between electrodes 1 and 2 in isolation is used for the x axis. The magnitude of the alternating voltage between electrodes 3 and 4 is constant resulting in a calculated maximum field component of 38,090 Vᵣₘₛ m⁻¹ (the actual field strength and direction can be calculated by a vector sum).

The combined effect on the HCP crystal structure was to stretch it along one axis. The presence of fluid flow during the experiments was noted to skew the HCP structure, causing it to approach a cubic close packed (CCP) configuration. The ability to distort the lattice in this manner can be used to enhance the size of the photonic band gap.

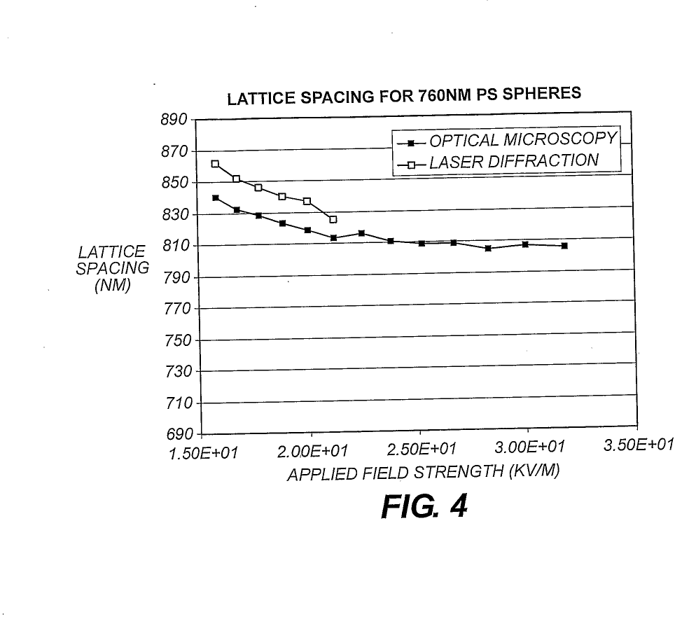

The experimental setup described in FIG. 1 was used to control the lattice spacing of 760 nm polystyrene latex spheres (determined by Jeol JSM-6330F SEM) suspended in 0.01 mM KCl. In this case the electrodes had rounded ends to avoid regions of high electric field at the tips. A rotating electric field was applied to the co-planar quadrapole electrode system, with a frequency of 1000 Hz; the field strength was varied between 15-35 Kvm⁻¹. The lattice spacing of the crystal was determined by two different methods; first, from optical microscopy images of the PS spheres in-situ, and second by observation and measurement of the spacing of the first order diffraction spots obtained by focusing a 635 nm light from a diode laser through the 2D crystal. The results are shown in FIG. 4.

FIG. 4 illustrates that the lattice spacing determined by laser diffraction (open squares) is consistently higher by around 20 nm that that determined from optical microscopy (solid squares). However spacing determined by both methods shows the same response to field strength, i.e. as field strength is increased the lattice spacing of the crystal decreases.

The table below shows observations of visible colour when the arrangement described in FIG. 4 is illuminated with white light incident at ˜30-50 degrees. In this experiment the field strength is kept constant at 35 Kvm⁻¹, whilst the direction and phase of the field is changed.

### Table Showing Visible Colour Changes as a Function of Electric Field Direction.

| Conditions | Observations |
|---|---|
| Electric field off | No visible Colour |
| Only signal amplifier 2 operating. | A circular region of bright Red/ |
| | Orange centred between all 4 |
| | electrodes. Blue lobes of colour |
| | localised around the top and bottom |
| | electrodes. |
| Only signal amplifier 1 operating. | Colourless central region, with lobes |
| | of blue and orange localised around |
| | the left and right electrode. |
| Both signal amplifiers operating | Broad patch of blue colour |
| with a phase shift of 0°. | orientated diagonally from bottom |
| | left to top right, flanked by orange |
| | lobes centred on all four electrodes. |
| Both signal amplifiers operating | Colourless central region with blue |
| with a phase shift of 90°. | lobes of colour orientated diagonally |
| | between all four electrodes, orange |
| | lobes of colour localised around left |
| | and right electrodes. |
| Both signal amplifiers operating | Broad patch of blue colour |
| with a phase shift of 180°. | orientated diagonally from bottom |
| | right to top left, flanked by orange |
| | lobes centred on all four electrodes. |
| Both signal amplifiers operating | Colourless central region with blue |
| with a phase shift of 270°. | lobes of colour orientated diagonally |
| | between all four electrodes, orange |
| | lobes of colour localised around left |
| | and right electrodes. |
| Both signal amplifiers operating | Colourless central region with blue |
| with a phase shift of 90° or | lobes of colour orientated diagonally |
| 270°, alternating every cycle. | between all four electrodes, orange |
| | lobes of colour localised around left |
| | and right electrodes. |

In these experiments the monodisperse spheres are assembled into chains, aligned along the electric field direction. By using this arrangement to actively control the alignment of the chains it is possible to tune the wavelength of the reflected light. The ensemble of chains acts as a diffraction grating with a grating period dependent on the angle subtended by the incident light and the long axis of the chains. A further benefit of this arrangement is that the selected wavelength of light scattered normal to the spheres shows little variation with viewing angle.

The experiments described above demonstrate the rapid assembly of colloidal crystals in an electric field. In addition, they demonstrate the control over the rotation of the crystals and the dynamic, rapid, reversible control over the lattice spacing along independent axes. The ability to interactively tune the lattice spacing of a photonic crystal is of particular use in optoelectronics for tuneable filter elements, or flat lenses with tuneable optical properties, and also in the display industry where it can be used as part of a tuneable colour element in a display or as tuneable optical filter for a CCD, CMOS or other image capture device, for example film camera or thermal imager. An alternative approach might use a field sequential mode of capture or display wherein the red, green and blue fields are either captured or displayed sequentially.

By choosing the size of the colloidal particles appropriately the device can be used to control different regions of the electromagnetic spectrum. For instance, particles in the size range of 100-600 nm might be used for a device to operate in the visible part of the spectrum, whilst particles in the micrometer size range would be used to make a device operate in the infrared region of the spectrum. Use of even larger particles would allow operation in the terahertz and microwave region of the spectrum.

In addition to the use of monodisperse spheres of polystyrene or silica functionalised spheres might also be used, or spheres that have a core particle with a shell of different material or materials such as ceramics, metal oxides or salts, polymers or a layer of metal to manipulate surface plasmons or enhance the photonic band gap. Furthermore, hollow particles or bubbles to provide a greater dielectric contrast between the suspending liquid and the particles could be used. Hollow particles also provide the assembled lattice with two distinct length scales for the inside and outside of the shell, which can be utilised to improve the band gap. A further refinement would be to use hollow particles with a plurality of alternating layers of material with different dielectric constant to create multiple, controllable length scales. Another method to achieve a larger band gap is to use two distinct sizes of monodisperse spheres and adjust the ratio of the amounts of each size to alter the resultant packing structure of the lattice. A variation on this approach is to use asymmetric particles such as oval, rod or plate shaped particles with an aspect ratio greater than unity to change the packing symmetry. These differently shaped particles may be used separately or in combination. Furthermore it is possible to use a limited coalescence emulsion that has monodisperse droplets, for example liquid or polymer, stabilised by particles bound to the droplet surface, in this manner the droplets can be given surface charge by using stabilising particles that develop a surface charge. The droplets could consist of or contain a liquid crystal material that changes its dielectric properties upon application of an electric field, offering further-opportunities to selectively tune the optical response of the photonic crystal.

The particles described in the examples have a fixed charge on their surface, which provides the repulsive force that keeps them separated. This force is balanced by the attractive dipole forces generated by the electric field. However, the minimum requirement is a mutual repulsion of the particles that can be provided by other means such as steric repulsion due to an adsorbed layer or layers, comprising surfactant or oligomer or polymer, or of charged particles or other dispersant on the particle surface for instance, thus relaxing the requirement for a permanent surface charge.

The invention has been described in detail with reference to preferred embodiments thereof. It will be understood by those skilled in the art that variations and modifications can be effected within the scope of the invention.

1. A method of controlling the particle spacing of a regular lattice of substantially monodisperse particles or mixture of monodisperse particles by use of an electric field, wherein voltage is supplied by two or more pairs of electrodes each pair of electrodes being coupled to an independent voltage source wherein the relative phase of the voltage source is controlled.

2. A method as claimed in 1, wherein said lattice of particles forms a photonic crystal.

3-4. (canceled)

5. A method as claimed in claim 1, wherein the frequency of the applied field is between 100 Hz and 20 kHz.

6. A method as claimed in claim 5, wherein the frequency of the applied field is between 1000 Hz and 10 kHz.

7. A method as claimed in claim 1, wherein the particle size is in the range of 100 nm to 600 nm.

8. A method as claimed in claim 1, wherein the particle size is in the range of 600 nm-1000 μm.

9-10. (canceled)

11. A method as claimed in claim 1, wherein the particles have a layer or layers comprising surfactant or oligomer or polymer or of smaller charged particles to create a steric repulsion between particles that renders the particles mutually repulsive.

12-13. (canceled)

14. A method as claimed in claim 1, wherein the crystal lattice structure is systematically shifted from hexagonal close packed or face centred cubic to a cubic close packed structure by application of forces of different magnitude along different axes to enhance the photonic band gap.

15. A method as claimed in claim 1, wherein the crystal lattice symmetry is systematically shifted by inclusion of high aspect ratio particles such as oval, rod or plate shaped particles, or other non spherical particles.

16. A method as claimed in claim 1, wherein the crystal lattice symmetry is systematically shifted by using a mixture of two or more particle sizes where the ratio of the sizes is adjusted to so that the lattice symmetry of the larger particles can be changed by choosing the smaller particle size appropriately.

17. A method as claimed in claim 1, wherein the particles used to assemble the lattice are hollow, having at least one layer of metal or dielectric materials or a combination of metal and dielectric materials.

18. (canceled)

19. A method as claimed in claim 2, wherein the particles used to assemble the photonic crystal comprise polymer, organic, inorganic, ceramic, metal, metal oxide or metal salts or metal coated particles.

20. A method as claimed in claim 1, wherein the particles used are monodisperse liquid drops of a limited coalescence emulsion stabilised by adsorption of charged particles at the interface.

21. A method as claimed in claim 20, wherein the liquid drops consist of or contain a liquid crystal material to allow further tuning of the optical response.

22. A method as claimed in claim 1, wherein the particles are suspended within a liquid crystal material to allow further tuning of the optical response.

23. A method of fabricating a tuneable colloidal photonic crystal device wherein the lattice spacing within the suspension based crystal is controlled by the application of an electric field to the suspension.

24. A suspension based photonic crystal device having reversibly tuneable photonic properties the lattice dimension being controlled by the method according to claim 1.

25. A suspension based photonic crystal colour filter device having reversibly tuneable photonic properties the lattice dimension being controlled by the method according to claim 1, that can be used to selectively reflect or transmit certain wavelengths of light, as part of a reflective or emissive display or as part of a filter array on a CMOS or CCD or other image capture element.

26. A suspension based photonic crystal colour filter device having reversibly tuneable photonic properties, the device comprising chains of particles that form a diffraction grating with a period determined by the angular orientation of the chains, being controlled by the method according to claim 1, that can be used to selectively reflect or transmit certain wavelengths of light, as part of a reflective or emissive display or as part of a filter array on a CMOS or CCD or other image capture element.

27-28. (canceled)

29. A suspension based photonic crystal colour filter device having reversibly tuneable photonic properties the lattice dimension being controlled by the method according to claim 1, that can be used to selectively reflect or transmit certain wavelengths of light, as part of an image capture or display device operated in field sequential mode.

30. A suspension based photonic crystal colour filter device having reversibly tuneable photonic properties, the device comprising chains of particles that form a diffraction grating with a period determined by the angular orientation of the chains, being controlled by the method according to claim 1, that can be used to selectively reflect or transmit certain wavelengths of light, as part of an image capture or display device operated in field sequential mode.

31. (canceled)

32. A suspension based photonic crystal device having reversibly tuneable photonic properties the lattice dimension being controlled by the method according to claim 1, using materials to create a tuneable negative refractive index flat lens device.
